(19) United States
(12) Patent Application Publication
(10) Pub. No.: US 2026/0277020 A1
(43) Pub. Date: Sep. 17, 2026

(54) NOSE PAD AND SMART GLASSES

(71) Applicant: Goertek Technology Co., Ltd., Shandong (CN)

(72) Inventor: Zhonggen Qian, Shandong (CN)

(73) Assignee: Goertek Technology Co., Ltd., Shandong (CN)

(21) Appl. No.: 19/168,382

(22) PCT Filed: Oct. 30, 2024
(86) PCT No.: PCT/CN2024/128443

§ 371 Date: Sep. 24, 2025

(30) Foreign Application Priority Data
Nov. 21, 2023 (CN) 202323147878.1

(51) Int. Cl. G02C 5/12

(52) U.S. Cl. CPC G02C 5/122

(57) ABSTRACT

The disclosed subject matter provides a nose pad and smart glasses. The nose pad is used for the smart glasses. The nose pad includes a support member and a bone conduction component. The support member includes a first support portion; the bone conduction component includes a vibration module and a MEMS module. The vibration module includes a vibration cavity and a vibration member dividing the vibration cavity into two parts. The vibration cavity has a first end wall and a second end wall opposite to the vibration member. At least one of a distance between the vibration member and the first end wall and a distance between the vibration member and the second end wall is greater than a maximum amplitude of the vibration member. The MEMS module has a detection port in communication with the vibration cavity.

### CROSS-REFERENCE TO RELATED APPLICATIONS

The application is a National Stage of International Application No. PCT/CN2024/128443, filed on Oct. 30, 2024, which claims priority to Chinese patent application No. 202323147878.1, filed with the Chinese Patent Office on Nov. 21, 2023, and entitled “NOSE PAD AND SMART GLASSES”, both of which are hereby incorporated by reference in their entireties.

### TECHNICAL FIELD

The present disclosure relates to the field of electronic devices technology, and in particular relates to a nose pad and smart glasses.

### BACKGROUND

With the continuous development of computer technology, electronic technology, and network application technologies, electronic devices such as smart glasses are increasingly being integrated into daily life.

Examples of current smart wearable devices include smart audio glasses, AR (Augmented Reality)/VR (Virtual Reality), etc., which are typically equipped with functionalities such as voice calling, voice wake-up, and voice recognition. As smart wearable devices trend toward thinner and lighter designs, the demand for more diverse application scenarios is also growing. In outdoor or industrialized environments, due to wind noise and high ambient noise (environmental noise), etc., the voice signal captured by the microphone may be easily overwhelmed by high wind noise and strong environmental noise, hair contact noise, etc. Even after processing by noise reduction algorithms, the voice signal cannot be effectively extracted, resulting in unsatisfactory performance in voice calling, voice wake-up, and voice recognition, or even rendering the microphone inoperable. Therefore, there is an urgent need for a voice recognition structure to address the aforementioned issues.

### SUMMARY

The main objective of the present disclosure is to provide a nose pad and smart glasses, aiming to provide a nose pad with bone conduction functionality for use in smart glasses for voice calling, voice wake-up, voice recognition, etc.

In order to achieve the above purpose, the present disclosure provides a nose pad for smart glasses, comprising:
a support member, comprising a first support portion; and
a bone conduction component, comprising a vibration module and a MEMS module, both the vibration module and the MEMS module being provided on the first support portion, the vibration module including a vibration cavity and a vibration member dividing the vibration cavity into two parts, the vibration cavity having a first end wall and a second end wall opposite to the vibration member, a distance between the vibration member and the first end wall and/or a distance between the vibration member and the second end wall being greater than a maximum amplitude of the vibration member, the MEMS module having a detection port in communication with the vibration cavity, the vibration module being configured to capture vibration produced by a user during vocalization, for vibrating air within the vibration cavity, the MEMS module being configured to capture, through air vibrating within the vibration cavity, vibration signal produced by the user during vocalization, and to feedback the vibration signal to a control device on smart glasses.

Optionally, the vibration member comprises a diaphragm and a mass block provided on the diaphragm.

Optionally, the mass block occupies a partial region of the diaphragm such that the diaphragm has an outer ring surrounding the mass block.

Optionally, the vibration cavity is divided into a first chamber and a second chamber by the diaphragm, the mass block is located in the first chamber, and a size of the first chamber in the vibration direction of the vibration member is greater than a size of the second chamber in the vibration direction of the vibration member.

Optionally, the second chamber is provided with a vent hole in communication with the detection port.

Optionally, the vibration cavity is provided with a vent hole;
an opening area of the detection port is not greater than an opening area of the vent hole.

Optionally, the support member comprises two support portions, one on each side of a nose, one of the support portions being the first support portion, the bone conduction component being installed at least on the first support portion, and being provided close to a free end of the first support portion.

Optionally, the vibration cavity is provided with a vent hole, and the detection port docks with the vent hole.

Optionally, an inner cavity of the MEMS module is in communication with the vibration cavity to form a closed chamber.

Optionally, the detection port is in communication with the vibration cavity through a communication chamber.

Optionally, an inner cavity of the MEMS module, the communication chamber, and the vibration cavity are in communication to form a closed chamber.

Optionally, the first support portion is covered by a covering shell, both the MEMS module and the vibration module are provided within the covering shell, the vibration module is provided with a vent hole in communication with the vibration cavity and the inner cavity of the covering shell, and the inner cavity of the covering shell forms the communication chamber.

Optionally, the first support portion is provided with a communicating hole extending through its two sides, the MEMS module and the vibration module are provided on either side of the first support portion, and hermetically dock with two ends of the communicating hole.

Optionally, a width of a region of the first support portion corresponding to the vibration cavity is D1, a width of the communicating hole is D2, and D2≥0.1D1.

Optionally, the MEMS module comprises a circuit board and a MEMS sensor provided on the circuit board, the circuit board covers the communicating hole, the detection port is provided on the circuit board and in communication with the inner cavity of the MEMS sensor, the detection port is in communication with the communicating hole, and the circuit board is hermetically attached to a periphery of the communicating hole.

Optionally, a sealing ring surrounding the communicating hole is provided between the circuit board and the first support portion.

Optionally, the vibration module comprises a diaphragm provided within the vibration cavity.

Optionally, the vibration module further comprises a mass block provided on the diaphragm.

Optionally, the nose pad is applied to smart glasses, and the nose pad further comprises an installation portion connected to the support member, which is configured to be detachably installed on a main body of the smart glasses.

Optionally, the vibration module is provided with a vent hole in communication with the vibration cavity and the detection port:
wherein the vent hole is provided at one end of the vibration module facing away from the first support portion; or,
the vent hole is provided on a side of the vibration module; or
the vent hole in communication with the vibration cavity extends through the first support portion.

The present disclosure further provides smart glasses comprising a main body of the glasses and a nose pad. The support member of the nose pad is integrally formed with the main body of the glasses, or the support member of the nose pad is detachably installed on the main body of the glasses through an installation portion. The nose pad comprises the support member and a bone conduction component. The support member comprises a first support portion. The bone conduction component comprises a vibration module and a MEMS module, both the vibration module and the MEMS module being provided on the first support portion, the vibration module including a vibration cavity and a vibration member dividing the vibration cavity into two parts, the vibration cavity having a first end wall and a second end wall opposite to the vibration member, a distance between the vibration member and the first end wall and/or a distance between the vibration member and the second end wall being greater than a maximum amplitude of the vibration member, the MEMS module having a detection port in communication with the vibration cavity, the vibration module being configured to capture vibration produced by a user during vocalization, for vibrating air within the vibration cavity, the MEMS module being configured to capture, through air vibrating within the vibration cavity, vibration signal produced by the user during vocalization, and to feedback the vibration signal to a control device on smart glasses.

In the technical solution of the present disclosure, the main objective is to prevent environmental wind noise and ambient noise from interfering with the smart glasses in acquiring the user's voice signal. To achieve this, the detection port of the MEMS module is placed in communication with the vibration cavity of the vibration module. The vibration module receives the vibration produced by the user, during vocalization and generates corresponding air flow within the vibration cavity, thereby converting structural vibration into air vibration. This air vibration is transmitted to the MEMS module through the communication between the detection port and the vibration cavity. Thus, both the generation and the detection of the air vibration both occur within the structure formed by the communication between the detection port and the vibration cavity, and thus are not influenced by external wind noise or strong ambient noise. Since the air vibration originates from the vibration module receiving user's vocalization, it is inherently associated with the user's voice signal. As a result, the MEMS module can detect and identify the user's voice signal while avoiding the detection of environmental wind noise and ambient noise. This significantly reduces the impact of environmental wind noise and ambient noise on the acquisition of the user's voice signal, enabling the smart glasses to effectively extract the user's voice signal even in a complex noise environment, thereby meet the usage requirements in complex environments. Based on this, the vibration module in the present application mainly receives the user's vocalization vibration by bone conduction. Since the nose pad is located at a preferable position for bone vibration when speaking, the perception of bone conduction vibration by the vibration module provided on the nose pad is also preferable. High-sensitivity and high signal-to-noise ratio voice vibration signals can be produced, greatly improving the quality of the obtained voice signals. Consequently, the device achieves good voice call noise reduction effects, as well as high wake-up rates and high recognition rates in voice wake-up/recognition.

### BRIEF DESCRIPTION OF THE DRAWINGS

In order to more clearly illustrate technical solutions in the embodiments of the present disclosure or the prior art, the following will briefly introduce the drawings that need to be used in the description of the embodiments or the prior art. Obviously, the accompanying drawings in the following description are only some embodiments of the present disclosure. For those skilled in the art, other drawings can also be obtained according to the structures shown in these drawings without creative effort.

FIG. 1 shows a stereoscopic view of a nose pad according to an embodiment of the present disclosure;

FIG. 2 is a stereoscopic view of a part of the nose pad shown in FIG. 1;

FIG. 3 is a cross-sectional view of the first embodiment of the nose pad shown in FIG. 1 at the location of the bone conduction component;

FIG. 4 is a cross-sectional view of the second embodiment of the nose pad shown in FIG. 1 at the location of the bone conduction component;

FIG. 5 is a cross-sectional view of the third embodiment of the nose pad shown in FIG. 1 at the location of the bone conduction component;

FIG. 6 is a stereoscopic view of smart glasses according to an embodiment of the present disclosure.

Explanation of reference numbers:

| reference number | name |
|---|---|
| 1000 | smart glasses |
| 100 | nose pad |
| 1 | support member |
| 11 | first support portion |
| 111 | communicating hole |
| 2 | bone conduction |
| | component |
| 21 | vibration module |
| 211 | vibration cavity |
| 2111 | first chamber |
| 2112 | second chamber |
| 211a | vent hole |
| 212 | diaphragm |
| 213 | mass block |
| 22 | MEMS module |
| 221 | MEMS sensor |
| 221a | detection port |
| 222 | circuit board |
| 3 | covering shell |
| 4 | sealing ring |
| 5 | installation portion |
| 6 | communication chamber |
| 200 | main body of glasses |

The implement of the purpose, functional characteristics and advantages of the present disclosure will be further described in conjunction with the embodiments and with reference to the accompanying drawings.

### DETAILED DESCRIPTION

The following will clearly and completely describe the technical solutions in the embodiments of the present disclosure with reference to the accompanying drawings in the embodiments of the present disclosure. Obviously, the described embodiments are only a part of the embodiments of the present disclosure, not all of them. Based on the embodiments of the present disclosure, all other embodiments obtained by persons of ordinary skill in the art without creative efforts fall within the protective scope of the present disclosure.

It should be noted that if there are directional indications (such as up, down, left, right, front, back . . . ) in the embodiment of the present disclosure, the directional indications are only used to explain the relative position relationship, motion situation, etc. between various components in a specific posture (as shown in the accompanying drawings). If the specific posture changes, the directional indication will also change accordingly.

In addition, if there are descriptions involving “first”, “second” and so on in the embodiments of the present disclosure, the descriptions of “first”, “second” and so on are only for descriptive purposes, and should not be interpreted as indicating or implying its relative importance or implicitly indicates the number of technical features indicated. Thus, the features defined as “first” and “second” may explicitly or implicitly include at least one of these features. Additionally, the term “and/or” used throughout the document means that three parallel solutions are included. For example, “A and/or B” includes A solution, or B solution, or both the A and B solutions being satisfied simultaneously. In addition, the technical solutions of the various embodiments can be combined with each other, but it must be based on that can be realized by those skilled in the art. When the combination of technical solutions is contradictory or cannot be realized, it should be considered that the combination of technical solutions does not exist, nor within the protective scope of the present disclosure.

With the continuous development of computer technology, electronic technology, and network application technology, electronic devices such as smart glasses are increasingly being integrated into daily life.

Examples of current smart wearable devices include smart audio glasses, AR/VR, etc., which are typically equipped with functionalities such as voice calling, voice wake-up, and voice recognition. As smart wearable devices trend toward thinner and lighter designs, the demand for more diverse usage scenarios is also growing. In outdoor or industrialized environments, due to wind noise and high noise (environmental noise), etc., the voice signal acquired by the microphone is easily overwhelmed by high wind noise and strong environmental noise. Even after processing by noise reduction algorithms, the voice signal cannot be effectively extracted, resulting in unsatisfactory performance in voice calling, voice wake-up, and voice recognition, or even rendering the microphone inoperable. Therefore, there is an urgent need for a voice recognition structure to address the aforementioned issues.

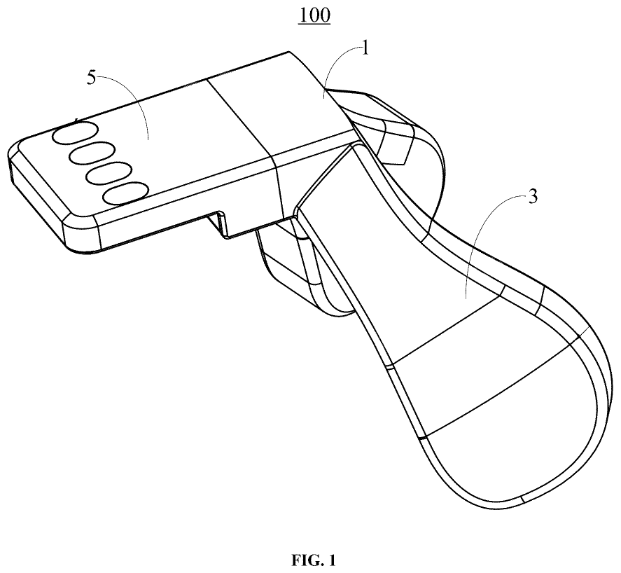

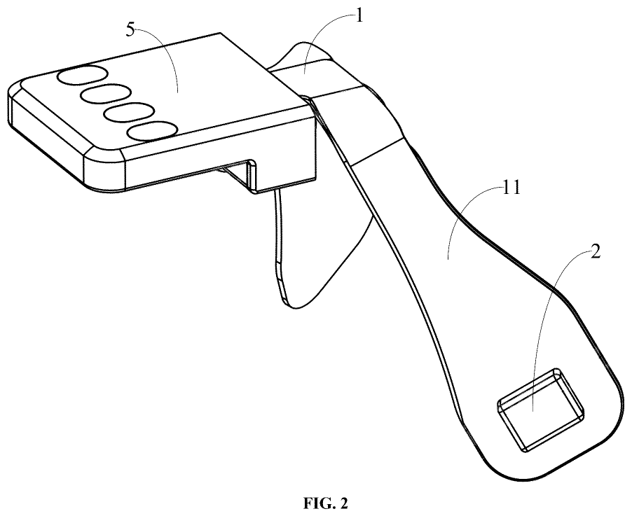

In view of this, the present disclosure provides a nose pad. FIGS. 1 to 5 are embodiments of the nose pad provided by the present disclosure. The following will describe the nose pad in detail with reference to the specific drawings.

Referring to FIGS. 1 to 5, the nose pad 100 is used for the smart glasses 1000. The nose pad 100 includes a support member 1 and a bone conduction component 2. The support member 1 includes a first support portion 11. The bone conduction component 2 includes a vibration module 21 and a MEMS module 22. Both the vibration module 21 and the MEMS module 22 are provided on the first support portion 11. The vibration module 21 includes a vibration cavity 211 and a vibration member (including a diaphragm 212 and a mass block 213) dividing the vibration cavity 211 into two parts. The vibration cavity 211 has a first end wall 211a and a second end wall 211b opposite to the vibration member. The distance between the vibration member and the first end wall 211a and/or the distance between the vibration member and the second end wall 211b is greater than the maximum amplitude of the vibration member. The MEMS module 22 has a detection port 221a, which is in communication with the vibration cavity 211. The vibration module 21 is configured to capture vibration produced by the user during vocalization, thereby vibrating the air within the vibration cavity 211. The MEMS module 22 is configured to capture, through air vibrating within the vibration cavity 211, vibration signal produced by the user during vocalization, and to feedback the vibration signal to the control device on the smart glasses 1000.

In the technical solution of the present disclosure, the main objective is to prevent environmental wind noise and ambient noise from interfering with the smart glasses 1000 in acquiring the user's voice signal. To achieve this, the detection port 221a of the MEMS module 22 is placed in communication with the vibration cavity 211 of the vibration module 21. The vibration module 21 receives the vibration produced by the user during vocalization and generates corresponding air flow within the vibration cavity 211, thereby converting structural vibration into air vibration. This air vibration is transmitted to the MEMS module 22 through the communication between the detection port 221a and the vibration cavity 211. Thus, both the generation and the detection of the air vibration occur within the structure formed by the communication between the detection port 221a and the vibration cavity 211, and thus are not influenced by external wind noise or strong ambient noise. Since the air vibration originates from the vibration module 21 receiving user's vocalization, it is inherently associated with the user's voice signal. As a result, the MEMS module 22 can detect and identify the user's voice signal while avoiding the detection of environmental wind noise and ambient noise. This significantly reduces the impact of environmental wind noise and ambient noise on the acquisition of the user's voice signal, enabling the smart glasses 1000 to effectively extract the user's voice signal even in a complex noise environment, thereby meeting the usage requirements in complex environments. Based on this, the vibration module 21 in the present application mainly receives the user's vocalization vibration by bone conduction. Since the nose pad 100 is located at a preferable position for bone vibration when speaking, the perception of bone conduction vibration by the vibration module 21 provided on the nose pad 100 is also preferable. High-sensitivity and high signal-to-noise ratio voice vibration signals can be produced, greatly improving the quality of the obtained voice signals. Consequently, the device achieves good voice call noise reduction effects, as well as high wake-up rates and high recognition rates in voice wake-up/recognition.

In addition, the distance between the vibration member and the first end wall 211a and/or the distance between the vibration member and the second end wall 211b is greater than the maximum amplitude of the vibration member. This can provide sufficient vibration space for the vibration member to avoid collision with the first end wall 211a and/or the second end wall 211b during vibration.

It should be noted that the vibration module 21 and the MEMS module 22 are independently provided on the first support portion 11. As long as the detection port 221a and the vibration cavity 211 can remain in stable communication, the communication mode can be various. Therefore, the positional relationship between the vibration module 21 and the MEMS module 22 does not need to be limited. The vibration module 21 is in communication with the MEMS module 22 by the corresponding communication mode which can be set to meet the above stable communication requirements. In addition, a MEMS (Micro-Electro-Mechanical System) microphone is used in the present application. Its structure is smaller in volume, which can reduce the structure volume of the bone conduction component 2 and facilitate being provided on the small nose pad 100. Moreover, the sensitivity of the MEMS (Micro-Electro-Mechanical System) microphone is more stable and less likely to be influenced by the environment, which is more practical.

In one embodiment, the support member 1 includes two support portions, one on each side of a nose. One of the support portions is the first support portion 11. The bone conduction component 2 is at least installed on the first support portion 11 and is provided close to a free end of the first support portion 11. It can be understood that when the first support portion 11 is disposed on the user's nose, its free end is close to the user's nasal cavity. When the user produces sound, the nasal cavity vibrates exhibits strong vibration. Therefore, based on the installation of the bone conduction component 2 on the first support portion 11, further limiting the bone conduction component 2 to be close to the free end of the first support portion 11 can further enhance the bone conduction vibration perception of the vibration module 21 of the nose pad 100, thereby further improving the quality of the obtained voice signal.

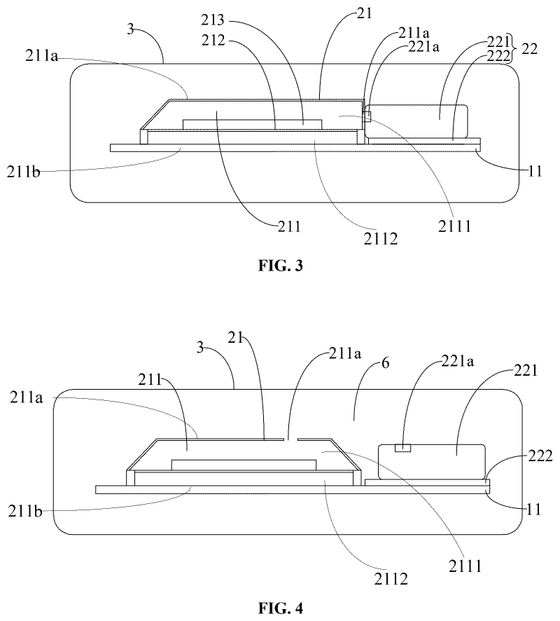

In addition, FIG. 3 is the first embodiment of the nose pad 100 provided in the present application. The vibration cavity 211 is provided with a vent hole 211a, and a detection port 221a of the MEMS module 22 docks with the vent hole 211a so that the detection port 221a is in communication with the vibration cavity 211. It can be understood that the shorter the communication path between the detection port 221a and the vibration cavity 211, the less the loss of vibration energy, which can further ensure the quality of the vibration sound signal detected and identified by the MEMS module 22. Therefore, in the embodiment, the vibration module 21 and the MEMS module 22 are arranged on the same side of the first support portion 11, and the vibration module 21 abuts with the MEMS module 22, so that the vent hole 211a on the vibration cavity 211 directly docks with to the detection port 221a on the MEMS module 22, thereby forming a short communication structure and obtaining a higher sound signal quality.

It can be understood that a communication channel formed by the communication between the vibration cavity 211 and the MEMS module 22 can be a completely closed structure or a common docking structure, i.e., a non-closed structure that does not need to consider gaps, as long as the communication channel can remain in stable communication and can perform the required function. However, the communication channel provided as a closed structure can obviously isolate external interference significantly and achieve better effects. Therefore, in the present application, the vibration cavity 211 and the inner cavity of the MEMS module 22 are in communication to form a closed chamber. Specifically, the way to form the closed structure is not limited here, including but not limited to sealing with sealant or sealing with a gasket on the contact surface, as long as the sealing function can be realized.

In addition, in some embodiments of the nose pad 100, the detection port 221a is in communication with the vibration cavity 211 through a communication chamber 6. The manner of directly docking the vent hole 211a on the vibration cavity 211 with the detection port 221a on the MEMS module 22 can obtain a higher sound signal quality. However, during the assembly process of the vibration module 21 and the MEMS module 22, the process precision requirement for accurately docking the vent hole 211a of the vibration cavity 211 with the detection port 221a of the MEMS module 22 is high, which leads to high cost. The structure that must abut with each other is relatively fixed and inflexible, and there may be cases where it is not applicable. Therefore, the present application further provides other embodiments. A communication chamber 6 is provided between the vibration cavity 211 of the vibration module 21 and the detection port 221a of the MEMS module 22 to communication them. The communication chamber 6 only needs to cover the opening of the vibration module 21 and the detection port 221a of the MEMS module 22, such that the vibration cavity 211 within the vibration module 21 is in communication with the detection port 221a of the MEMS module 22. There is no need for precise alignment therebetween, and the assembly is simple. The communication chamber 6 can be provided relatively freely, and there is no need to limit the relative position between the vibration module 21 and the MEMS module 22, which facilitates specific settings. At the same time, the structural design is simple, easy to design and manufacture, and can meet a variety of structural forms, which is more applicable.

It can be understood that, similar to the above manner of directly docking the vent hole 211a provided in the vibration cavity 211 with the detection port 221a on the MEMS module 22, the manner of communicating the detection port 221a and the vibration cavity 211 through the communication chamber 6 in the embodiment can also form a completely closed structure or a common docking structure. Based on the same determination as described above, in the embodiment, the communication chamber 6 communicates the vibration cavity 211 and the detection port 221a to form a closed chamber, which enhances the effect of isolating external interference and improves the sound collection effects.

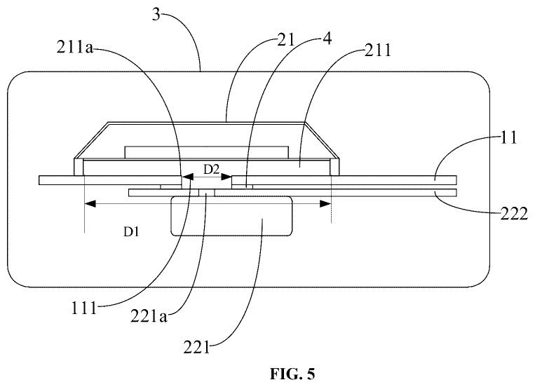

Specifically, FIG. 4 is the second embodiment of the nose pad 100 provided in the application. The first support portion 11 is covered by a covering shell 3, and both the MEMS module 22 and the vibration module 21 are provided within the covering shell 3. The vibration module 21 is provided with a vent hole 211a that communicates the vibration cavity 211 and an inner cavity of the covering shell 3. The inner cavity of the covering shell 3 forms the communication chamber 6. In some embodiments of the nose pad 100, it is only necessary to use the covering function of the covering shell 3 to enhance the user's wearing experience. In some embodiments, the covering shell 3 also needs to have an inner cavity to form the communication chamber 6. In the embodiment, the covering shell 3 have an inner cavity, so that the covering shell 3 and the first support portion 11 enclose to form the communication chamber 6. The vibration module 21 and the MEMS module 22 are disposed inside the covering shell 3, and the vent hole 211a of the vibration cavity 211 in the vibration module 21 is in communication with the detection port 221a on the MEMS module 22 through the communication chamber 6, thus achieving the communication. Apparently, this structural arrangement does not require additional structure to form the communication chamber 6, resulting in fewer parts, easier assembly, and reduced costs.

In addition, FIG. 5 is the third embodiment of the nose pad 100 provided in the present application. The first support portion 11 is provided with a communicating hole 111 that extends through its two sides. The MEMS module 22 and the vibration module 21 are arranged on the two sides of the first support portion 11, and hermetically dock with the two ends of the communicating hole 111 respectively. Similar to the first embodiment of the nose pad 100 mentioned above, when the MEMS module 22 and the vibration module 21 are arranged on either side of the first support portion 11 respectively, in order to shorten the communication path between them, in the embodiment, a communicating hole 111 is provided in the first support portion 11, and the vibration cavity 211 is in communication with the detection port 221a of the MEMS module 22 via the communicating hole 111. In this way, the attenuation of air flow fluctuations in the communication path is reduced, thereby improving the quality of the obtained voice signal.

Furthermore, the width of the region of the first support portion 11 corresponding to the vibration cavity 211 is D1, and the width of the communicating hole 111 is D2, where D2≥0.1D1, to ensure the size of the through-hole 111 for convenient exhaust.

Specifically, the MEMS module 22 includes a circuit board 222 and a MEMS sensor mounted on the circuit board 222. The circuit board 222 is configured to cover the communicating hole 111. The detection port 221a is provided on the circuit board 222 and is in communication with the inner cavity of the MEMS sensor, and the detection port 221a is in communication with the communicating hole 111. The circuit board 222 is sealed and attached to the periphery of the communicating hole 111. The MEMS sensor needs to be electrically connected to a control device on the smart glasses 1000 through an electrical connection structure, which can be a connecting wire structure. That is, the MEMS sensor is fixed on the first support portion 11 and then connected to the control device on the smart glasses 1000 through the connecting wire structure. In the present application, the circuit board 222 is attached to the first support portion 11, and the MEMS sensor is attached onto the circuit board 222, such that the MEMS sensor is fixed and connected to the control device of the smart glasses 1000. This method facilitates installation and ensures strong stability. It should be noted that in the above solution, a communicating hole 111 needs to be provided in the first support portion 11 to allow the detection port 221a on the MEMS sensor to dock with the communicating hole 111, and the circuit board 222 should adaptively provide an avoidance hole at the corresponding position to meet the docking requirement between the MEMS sensor and the communicating hole 111.

Furthermore, to ensure the sealing degree at the docking location between the MEMS sensor and the communicating hole 111, a sealing ring 4 is provided between the circuit board 222 and the first support portion 11, which is arranged around the periphery of the communicating hole 111 to enclose the communicating hole 111 and the avoidance hole on the circuit board 222.

In addition, the vibration module 21 includes a diaphragm 212 provided within the vibration cavity 211. The vibration module 21 is mainly configured to receive the vibration produced by the user, and convert the vibration into air vibration within the vibration cavity 211. That is, a structure that vibrates when the user produces sound to disturb the air within the vibration cavity 211 needs to be provided inside the vibration module 21. There are many types of such structures, including vibration rods and diaphragms, all of which can achieve similar functions. In the implementation of the present application, the diaphragm 212 is provided within the vibration cavity 211. The solution is more mature within an acoustic structure, thereby ensuring greater stability. Additionally, it can be understood that the diaphragm 212 can also serve as a wall of the vibration cavity 211, but its vibration direction is bidirectional. Even with such a configuration, a avoidance space still needs to be provided on the side facing away from the vibration cavity 211. Therefore, in the present application, the diaphragm 212 is directly provided within the vibration cavity 211, covering a cross-section of the vibration cavity 211 to provide bidirectional vibration space. Moreover, the diaphragm 212 is provided inside the vibration cavity 211, to further achieve a certain degree of protective effect.

Furthermore, the vibration module 21 also includes a mass block 213 provided on the diaphragm 212. The diaphragm 212 generally has a light structure and low mass, resulting in a small inertia. When the vibration module 21 vibrates with the user's nose, the diaphragm 212 cannot follow the motion in a timely manner. Moreover, the diaphragm 212 is subject to the gas resistance within the vibration cavity 211, which leads to a small vibration amplitude and negatively influences the generation of airflow fluctuations within the vibration cavity 211. This, in turn, influences the quality of subsequent sound capture. Therefore, the present application provides the mass block 213 on the diaphragm 212 to improve the above situation without influencing the function of the diaphragm 212 in driving the airflow fluctuations within the vibration cavity 211.

Furthermore, the mass block 213 occupies a partial region of the diaphragm 212, such that the diaphragm 212 has an outer ring surrounding the mass block 213. This outer ring maintains the elasticity of the diaphragm 212, facilitating its vibrational deformation.

Furthermore, the vibration cavity 211 is divided into a first chamber 2111 and a second chamber 2112 by the diaphragm 212, with the mass block 213 located in the first chamber 2111. The dimension of the first chamber 2111 in the vibration direction of the vibrating member is greater than that of the second chamber 2112 in the vibration direction of the vibrating member, thereby providing sufficient vibration space for the mass block 213 in the first vibration chamber 2111.

In one embodiment, the second chamber 2112 is provided with a vent hole 211a that is in communication with the detection port 221a, so as to facilitate exhausting.

In addition, the nose pad 100 further includes an installation portion 5 connected to the support member 1, which is detachably installed on the main body of glasses 200 of the smart glasses 1000. The nose pad 100 can be integrally formed with the smart glasses 1000. Considering that the nose pad 100 contains electronic components, which may require maintenance, repair, and replacement later. Therefore, in the present application, the nose pad 100 is designed to be detachably connected to the smart glasses 1000, and the installation portion 5 used for the detachable connection with the smart glasses 1000, is designed as an independent and detachable structure.

In addition, the vibration module 21 is provided with a vent hole 211a in communication with the vibration cavity 211 and the detection port 221a. Wherein the vent hole 211a is provided at one end of the vibration module 21 facing away from the first support portion 11; or, the vent hole 211a is provided on a side of the vibration module 21; or, the vent hole in communication with the vibration cavity extends through the first support portion. It can be understood that the specific location of the vent hole 211a of the vibration module 21, which is in communication with the vibration cavity 211, is mainly determined by the actual connection mode between the vibration module 21 and the MEMS module 22. Based on the above embodiments, the present application mainly proposes three configurations, including but not limited to being provided at one end of the vibration module 21 facing away from the first support portion 11, being provided on one side of the vibration module 21, and being provided through the first support portion 11. The specific configuration is mainly based on actual needs and is not specifically limited, as long as it can meet the communication requirements.

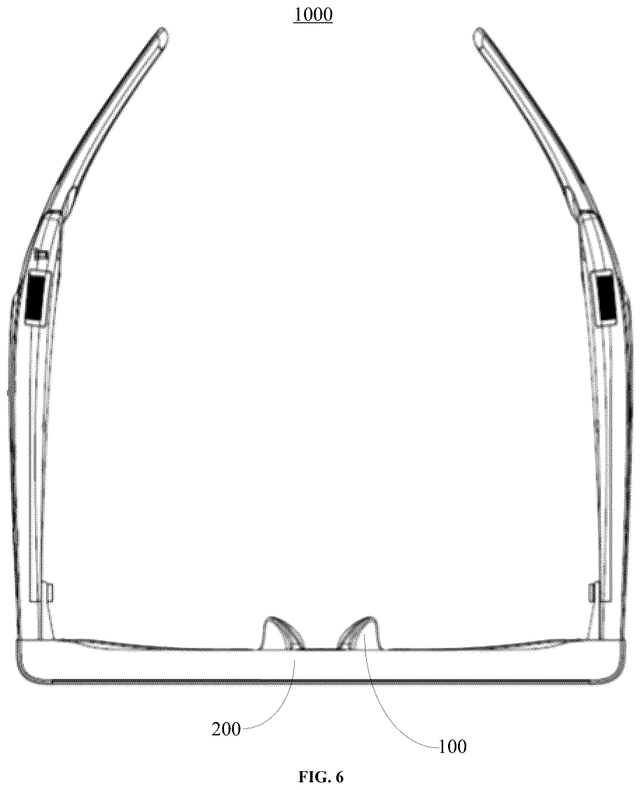

See FIG. 6, the present disclosure further provides smart glasses 1000, which include a main body of the glasses 200 and a nose pad 100. The support member 1 of the nose pad 100 is integrally formed with the main body of the glasses 200, or the support member 1 of the nose pad 100 is detachably installed on the main body of the glasses 200 through an installation portion 5. The specific structure of the nose pad 100 refers to the above embodiments. Since the smart glasses 1000 adopt all the technical solutions of the above embodiments, it therefore has at least all the beneficial effects brought by the technical solutions of the above embodiments, which will not be described in detail here.

The above are only preferred embodiments of the present disclosure, and are not intended to limit the scope of the present disclosure. Under the inventive concept of the present disclosure, any equivalent structural modifications made based on the contents of the description and the accompanying drawings of the present disclosure, or any direct or indirect application in other relevant technical fields, are all encompassed within the protective scope of the present disclosure.

1. A nose pad, comprising:
a support member, comprising a first support portion; and
a bone conduction component, comprising a vibration module and a MEMS module, both the vibration module and the MEMS module being provided on the first support portion, the vibration module including a vibration cavity and a vibration member dividing the vibration cavity into two parts, the vibration cavity having a first end wall and a second end wall both opposite to the vibration member, at least one of a distance between the vibration member and the first end wall and a distance between the vibration member and the second end wall being greater than a maximum amplitude of the vibration member, the MEMS module having a detection port in communication with the vibration cavity, the vibration module being configured to capture vibration produced by a user during vocalization, to cause air within the vibration cavity to vibrate, the MEMS module being configured to capture, through air vibrating within the vibration cavity, vibration signal produced by the user during vocalization, and to feedback the vibration signal to a control device on smart glasses.

2. The nose pad according to claim 1, wherein the vibration member comprises a diaphragm and a mass block provided on the diaphragm.

3. The nose pad according to claim 2, wherein the mass block is disposed in a partial region of the diaphragm such that the diaphragm has an outer ring surrounding the mass block.

4. The nose pad according to claim 2, wherein the vibration cavity is divided into a first chamber and a second chamber by the diaphragm, the mass block is located in the first chamber, and a dimension of the first chamber in a vibration direction of the vibration member is greater than a corresponding dimension of the second chamber in a vibration direction of the vibration member.

5. The nose pad according to claim 4, wherein the second chamber comprises a vent hole in communication with the detection port.

6. The nose pad according to claim 1, wherein the vibration cavity comprises a vent hole; an opening area of the detection port is not greater than an opening area of the vent hole.

7. The nose pad according to claim 1, wherein the support member comprises two support portions, one on each side of a nose, one of the support portions being the first support portion, the bone conduction component being installed at least on the first support portion, and the bone conduction component being provided proximate to a free end of the first support portion.

8. The nose pad according to claim 1, wherein the vibration cavity comprises a vent hole, and the detection port docks with the vent hole.

9. The nose pad according to claim 8, wherein the MEMS module comprises an inner cavity in communication with the vibration cavity to form a closed chamber.

10. The nose pad according to claim 1, wherein the detection port is in communication with the vibration cavity through a communication chamber.

11. The nose pad according to claim 10, wherein an inner cavity of the MEMS module, the communication chamber, and the vibration cavity are in communication to form a closed chamber.

12. The nose pad according to claim 11, wherein the first support portion is covered by a covering shell, the MEMS module and the vibration module are provided within the covering shell, the vibration module comprises a vent hole in communication with the vibration cavity and the inner cavity of the covering shell, and the inner cavity of the covering shell forms the communication chamber.

13. The nose pad according to claim 1, wherein the first support portion comprises a communicating hole extending between two sides thereof, the MEMS module and the vibration module are provided respectively on either end side of the first support portion, and hermetically dock with two corresponding ends of the communicating hole.

14. The nose pad according to claim 13, wherein a width of a region of the first support portion corresponding to the vibration cavity has a width D1, the communicating hole has a width D2, and D2≥0.1D1.

15. The nose pad according to claim 13, wherein the MEMS module comprises a circuit board and a MEMS sensor provided on the circuit board, the circuit board is configured to cover the communicating hole, the detection port is provided on the circuit board and in communication with an inner cavity of the MEMS sensor, the detection port is in communication with the communicating hole, and the circuit board is hermetically attached to a periphery of the communicating hole.

16. The nose pad according to claim 15, further comprises a sealing ring provided between the circuit board and the first support portion for surrounding the communicating hole.

17. The nose pad according to claim 1, wherein the nose pad is applied to the smart glasses, and the nose pad further comprises an installation portion connected to the support member, and the installation portion is configured to be detachably installed on a main body of glasses of the smart glasses.

18. The nose pad according to claim 1, wherein the vibration module comprises a vent hole in communication with the vibration cavity and the detection port:
wherein the vent hole is provided at one end of the vibration module facing away from the first support portion; or,
the vent hole is provided on a side of the vibration module; or
the vent hole in communication with the vibration cavity extends through the first support portion.

19. Smart glasses, comprising:
a main body of glasses; and
a nose pad according to claim 1, the support member of the nose pad being integrally formed with the main body of glasses, or the support member of the nose pad being detachably installed on the main body of glasses through an installation portion.
